(19) United States
(12) Patent Application Publication
(10) Pub. No.: US 2014/0190591 A1
(43) Pub. Date: Jul. 10, 2014

(54) Over-Fill Monitoring System

(71) Applicant: Marty Robert Scott, Granger, IN (US)

(72) Inventor: Marty Robert Scott, Granger, IN (US)

(21) Appl. No.: 13/738,964

(22) Filed: Jan. 10, 2013

(51) Int. Cl. B67D 7/32

(52) U.S. Cl. CPC B67D 7/3245
USPC 141/96; 141/95

(57) ABSTRACT

The over-fill monitoring system monitors the liquid level of a container as its being filled and visually indicates that the fill process should be stopped, thereby reducing the chance of over-filling and overflow spills. The over-fill monitoring system includes a fuel probe, a visual “fill limit” indicator, and an electronic control unit. The control unit is responsive to the fuel probe and activates the “fill limit” indicator during the fueling process when the fuel level within the tank reaches a predetermined “fuel fill” level. The control circuitry of the control unit also includes a “shut-down” timer, which deactivates the indicator light after a set period of time to prevent the control unit from drawing power from the battery.

This application claims the benefit of U.S. Provisional Patent Application, Ser. No. 61/631,793 filed Jan. 12, 2012.

This invention relates to a system for monitoring the filling of a liquid container to prevent inadvertent over-filling by providing a visual indication upon reaching a predetermined fill level, and in particular a monitoring system for use in marine vessels, motor vehicles and the like.

### BACKGROUND AND SUMMARY OF THE INVENTION

Over-filling of liquid containers is problematic in many applications, but particularly so for over filling fuel tanks. In addition, the manual filling of fuel tanks from small transfer cans and filling nozzles is a sloppy procedure. Over-filling of a fuel tank often results in an environmental hazard with the excess fuel spilling onto the ground or into waterways. Fuel tanks on outboards, I/O's, mowers, snowmobiles, garden and full size tractors, marine vessels and pleasure watercraft are typically small and require frequent refilling, which increases the opportunity for overflow spills.

The present invention provides an over-fill monitoring system, which monitors the liquid level of a container as it is being filled and visually indicates that the fill process should be stopped, thereby reducing the chance of over-filling and overflow spills. The over-fill system may be incorporated in a variety of devices, equipment and vehicles, but is particularly suited for watercraft. The over-fill monitoring system includes a modified a fuel probe, a “fill limit” indicator, and an electronic control unit. The “fill limit” indicator is a visible light, typically an LED light, which illuminates in response to an electrical signal from the control unit. The fuel probe uses a reed switch disposed within an elongated shaft disposed within the fuel tank and response to a magnet disposed within a fuel float that rides along the shaft. The control unit is responsive to the reed switch so that the “fill limit” indicator is activated (turned “on”) during the fueling process when the fuel level within the tank reaches a predetermined “fuel fill” level. The control unit and fuel probe function as “open” circuits, which allow the over-fill monitoring system to operate without drawing constant power from the batteries of host vehicle or vessel and without the ignition of the host vehicle or vessel being activated. The control circuitry of the control unit also includes a “shut-down” timer, which deactivates the indicator light after a set period of time. The shut down timer resets the control circuitry so that the over-fill monitoring system functions only when the tank is being filled and prevents the control unit from drawing power from the battery when the tank is full.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a simplified schematic of an embodiment of the liquid fill monitoring system of this invention;

FIG. 2 is a perspective view of a conventional watercraft using the liquid over-fill monitoring system of FIG. 1; and

FIG. 3 is a flow diagram of the system logic used by the liquid over-fill monitoring system of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

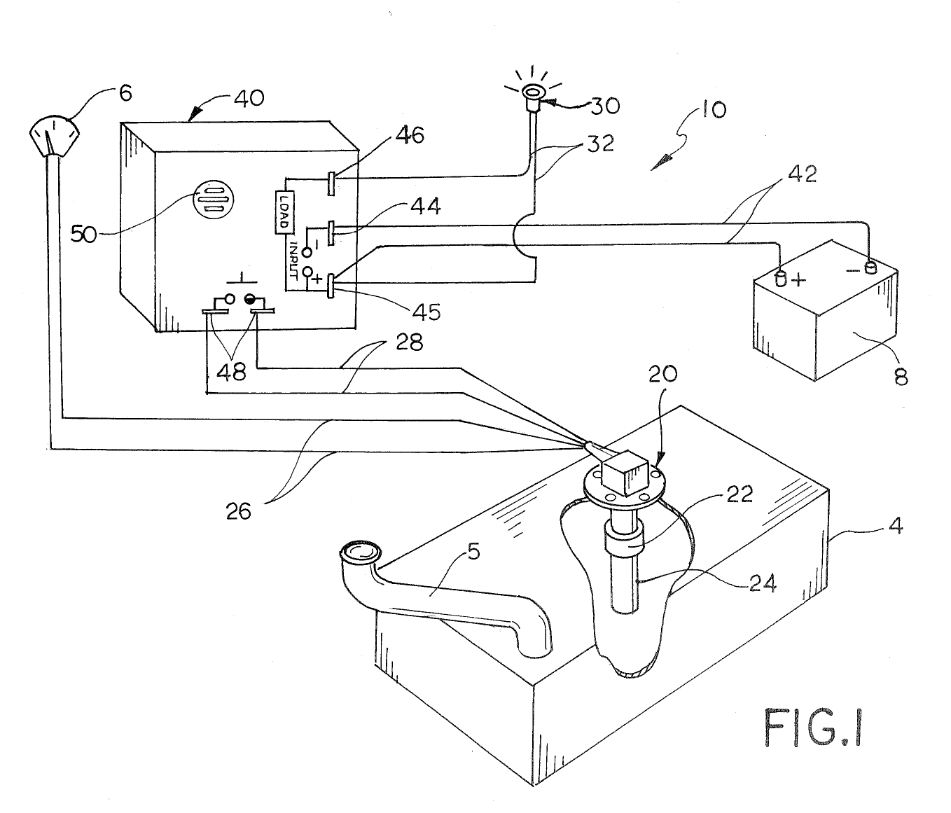

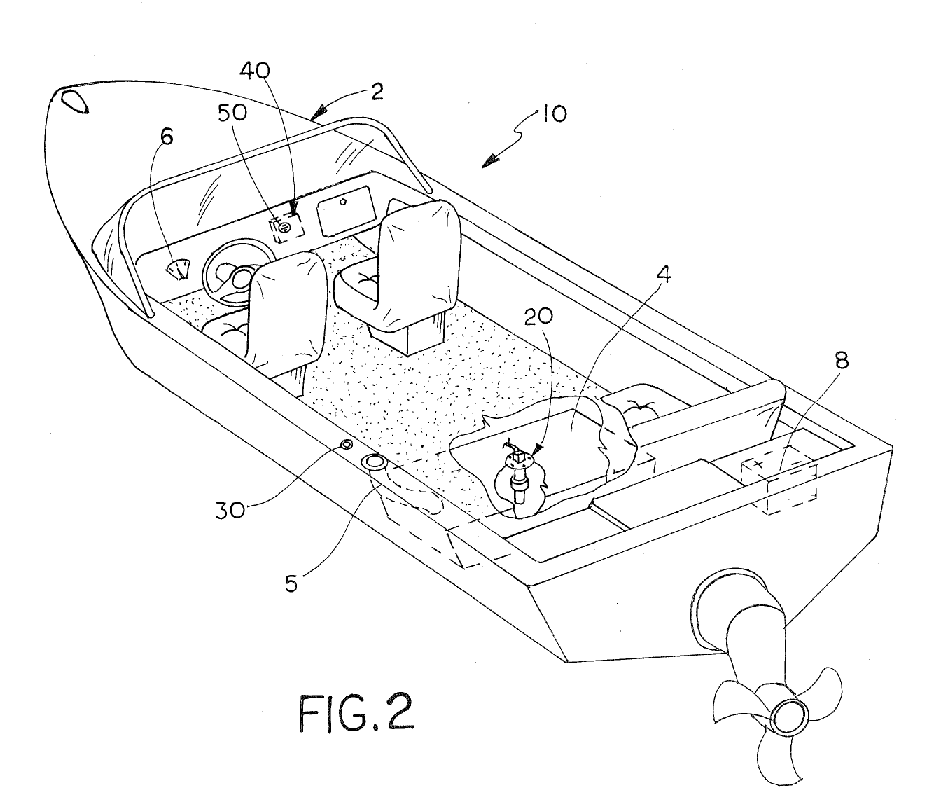

Referring now to the drawings, FIGS. 1-3 illustrate an embodiment of the liquid over fill monitoring system of this invention designated generally as reference numeral 10 used in a typical watercraft (boat) 2. Over-fill monitoring system 10 is designed to monitor the liquid level of a container as it is being filled to prevent over-filling and any resulting spillage. While illustrated and explained as part of a watercraft, the over-fill monitoring system 10 may be adapted for other applications, within the teachings of this invention. As shown FIG. 2, boat 2 includes a fuel tank 4 having a fill tube 5 accessible along the side rail of the boat and a fuel gauge 6. Boat 2 also includes a battery 8, which provides electrical power to the boat's various electrical systems and devices.

As shown in FIGS. 1 and 2, over-fill monitoring systems 10 includes a fuel probe 20, a “fill limit” indicator 30, and an electronic control unit 40. As shown in FIG. 2, “fill limit” indicator 30 is a visible light, typically an LED light, mounted to the side of boat 2 adjacent fill tube 5. As shown in the present embodiment, fuel probe 20 takes the form of a modified fuel sender. Fuel probe 20 includes a float 22, usually made of foam, which rides shiftably along a metal shaft 24. Float 22 includes a magnet (not shown), which is typically embedded with the body of the float. Shaft 24 houses to a reed switch (not shown), which is operably connected to control unit 40. The reed switch is normally “open” but “closes” in response to the proximity of the magnet field of the magnet in float 22. It should be noted that in the present embodiment, a modified fuel sender acts as a fuel probe 20. As shown, the modified fuel sender differs from conventional senders in that uses the magnet in the float and reed switches to sense fuel levels and includes two pairs of electrical leads 26 and 28. One set of electrical leads 26 is connected to the boat's fuel gauge 6. The other set of electrical leads 28 is connected to control unit 40.

Control unit 40 is mounted under the dash of boat 2 but may be located anywhere within the boat. Control unit 40 typically includes an enclosure, which houses its electrical circuitry (not shown). Control unit 40 is powered by battery 8. Leads 42 connect battery 8 to positive 44 and negative terminals 45 of control unit 40. Leads 28 connect fuel sender 20 to signal input terminals 48. Leads 32 connect “fill limit” indicator 30 to load terminal 46 and negative power terminal 45 of control unit 40. The electrical circuitry of control unit 40 includes various electrical components and is responsive to fuel probe 20, so that “fill limit” indicator 30 is activated (turned “on” and/or sounded) during the fueling process when the fuel level within tank 4 reach a predetermined “fuel fill” level. This “fuel fill” level is generally selected and set to correspond to be slightly less than the fuel capacity of tank 4, even though the “fuel fill” level may or may not read by fuel gauge 6 as slightly less than full capacity. As tank 4 is filled, float 22 moves up shaft 24 with the rising fuel level. When tank 4 has been filled to the predetermined “fuel fill” level, the magnetic field from the magnet in float 22 closes the reed switch in fuel probe 20 and control unit 40 activates fill level indicator 30, visibly alerting the person fueling the tank to stop fueling. Control unit 40 may also include an audible alarm, such as a buzzer, bell or horn that sounds in conjunction with fill limit indicator 30 when tank 4 has been fueled to the “fuel fill” level.

The control circuitry of control unit 40 and reed switch of fuel probe 20 operate as a normally “open” electrical circuits, i.e. the control unit 40 and fill limit indicator 30 is normally deactivated (“off’) and no current passes through fuel probe 20, so that over-fill system 10 draws only a minimum amount of power from battery 8. The control circuitry of control unit 40 also includes a “shut-down” timer (not shown), which deactivates the indicator light after a set period of time, typically 5-10 minutes). The shut down timer use by the circuitry of control unit 40 is of conventional design and its operation is generally understood in the electrical arts. The shut down timer resets the control circuitry so that fueling monitoring system 10 functions only when tank 4 is being filled and prevents control unit 40 from drawing power from the battery when the tank is full. The shut down timer also prevents the intermittent activation and deactivation of “fill limit” indicator 30 as the fuel level changes with the consumption of fuel by the boat's motors and/or the shifting of the fuel within tank 4 during the boat's operation.

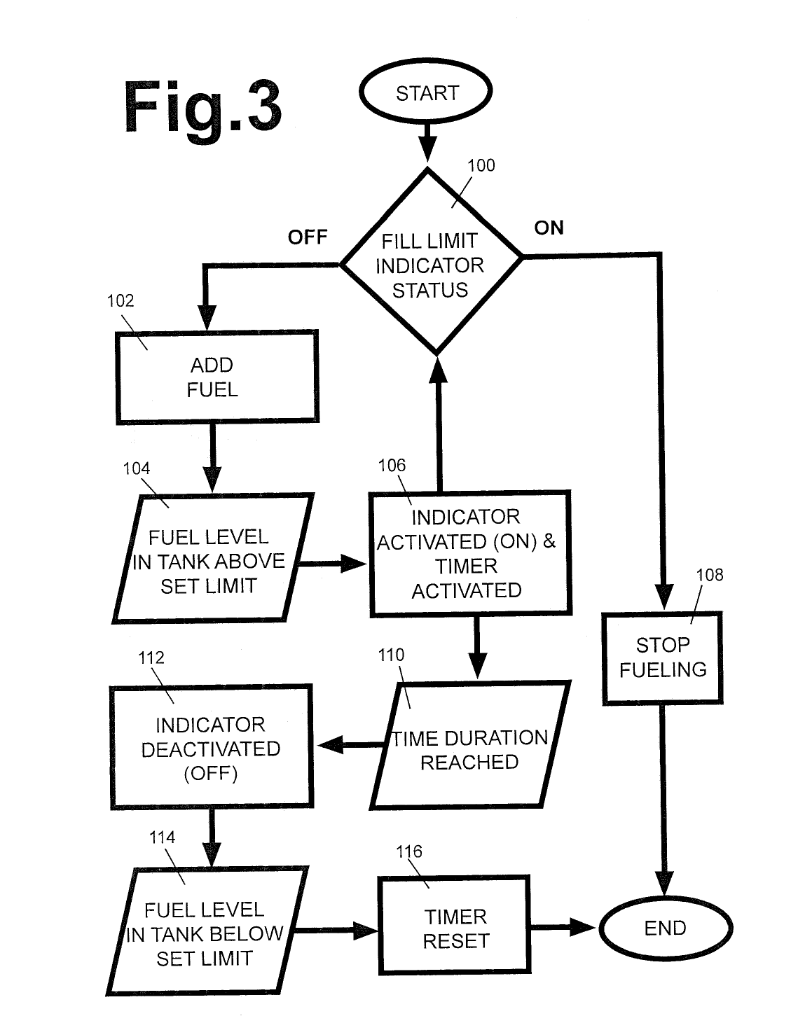

FIG. 3 is a simplified flow chart illustrating the basic logic steps of over-fill monitoring system 10 used in fueling a container, such as tank 4. In operation, over-fill monitoring system 10 begins with a determination of the status of “fill limit” indicator 30 in decision box 100. It should be noted that as in other such application, boat 2 is not refueled unless, fuel gauge 6 reads something less than a full tank. When fuel gauge 6 reads something less than “full,” “fill level” indicator light 30 is normally deactivated, that is turned “off.” If the “fill limit” indicator is deactivated, fuel is added to the tank in action box 102. Once the fuel level in tank 4 reaches the predetermined “full fill” level in input box 104, control unit 40 activates “fill limit” indicator 30 and the shut down timer in action box 106. With “fill limit” indicator 30 now activated or “on” fueling of tank 4 is terminated. Once the preset time established by the shut down timer has elapsed in input box 110, control unit 40 deactivates or turns off “fill limit” indicator 30 in action box 112. Once fuel in tank 4 drops below the “full fill” level in input box 114, control unit 40 resets the shut down timer in action box 116.

It should be apparent from the foregoing that an invention having significant advantages has been provided. One skilled in the art will note that the over-fill monitoring system of this invention visually alerts the person filling the tank that filling should be stopped, thereby preventing the overfilling of the tank and overflow due to expansion. The systems also reduces “spitback” or spillage during the act of filling. The over-fill monitoring system draws a minimum of electrical power from the host vehicle or vessel. The “fill limit” indicator will only indicate that the act of filling should be stopped for a predetermined amount of time, in order to conserve battery life. Moreover, functioning as “open” circuits, the control unit and the fuel probe allows the over-fill monitoring system to operate without constant power from the batteries of host vehicle or vessel and without the ignition of the host vehicle or vessel being activated.

While the invention is shown in only one of its forms, it is not limited to, but is susceptible to various changes and modifications without departing from the spirit thereof. Furthermore, the embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An over-fill monitoring system for indicating the fill level of a container when the container is being filled with a liquid, comprising:
a fuel probe for determining the fill level of the liquid within the container;
a visual indicator adapted to be activated between an illuminated state and an un-illuminated state; and
a control unit operatively connected to the visual indicator and the fuel probe and responsive to the fuel probe for activating the indicator from the un-illuminated state to the illuminated state once the fill level of the liquid within the container reaches a predetermined level and deactivating the indicator from the illuminated state to the un-illuminated state after a predetermined time.

2. The over-fill monitoring system of claim 1 fuel probe include an elongated shaft disposed within the container and a float shiftably mounted to the shaft, the floating includes a magnet connected thereto and the shaft includes a switch operatively connected to the control unit and responsive to the magnetic field of the magnet for closing the switch when the float is within predefined proximity of the switch.

3. The over-fill monitoring system of claim 2 wherein the fuel probe is a fuel sender.

4. The monitoring system of claim 1 wherein the control unit includes a shut down timer.

5. The over-fill monitoring system of claim 1 wherein the control unit also includes an audible alarm adapted to sound once the fill level of the liquid within the container reaches a predetermined level and silence after a predetermined time.

6. An over-fill monitoring system for indicating the fill level of the tank when the tank is being filled with fuel, comprising.
a fuel sender operatively disposed within the fuel tank for determining the fill level of the fuel within the tank;
a visual indicator adapted to be activated between an illuminated state and an un-illuminated state; and
a controller unit operatively connected to the visual indicator and the fuel sender and responsive to the fuel sender for activating the indicator from the un-illuminated state to the illuminated state once the fill level of the fuel within the tank reaches a predetermined level and deactivating the indicator from the illuminated state to the un-illuminated state after a predetermined time.

7. The over-fill monitoring system of claim 6 fuel probe include an elongated shaft disposed within the container and a float shiftably mounted to the shaft, the floating includes a magnet connected thereto and the shaft includes a switch operatively connected to the control unit and responsive to the magnetic field of the magnet for closing the switch when the float is within predefined proximity of the switch.

8. The monitoring system of claim 6 wherein the control unit includes a shut down timer.

9. The over-fill monitoring system of claim 6 wherein the control unit also includes an audible alarm adapted to sound once the fill level of the fuel within the tank reaches a predetermined level and silence after a predetermined time.
